(19) United States
(12) Patent Application Publication
(10) Pub. No.: US 2005/0195301 A1
(43) Pub. Date: Sep. 8, 2005

(54) Charge pump circuit and PLL circuit using the same

(76) Inventor: Hitoshi Horiuchi, Tokyo (JP)

Correspondence Address: FISH & RICHARDSON P.C., CITIGROUP CENTER 52ND FLOOR, 153 EAST 53RD STREET, NEW YORK, NY, 10022-4611, US

(21) Appl. No.: 11/069,815

(22) Filed: Feb. 28, 2005

(30) Foreign Application Priority Data
Mar. 2, 2004 (JP) P.2004-057356

(51) Int. Cl. H04N 5/335

(52) U.S. Cl. 348/294

(57) ABSTRACT

A charge pump circuit has a first transistor and a second transistor which constitute current mirror circuits with a reference transistor conducting a reference current, a first switch circuit which has a pair of transistors connected to the first transistor, and performs a switching operation with a differential between a positive signal and an inversion signal of a first signal to output a first output current to a first output terminal, and a second switch circuit which has a pair of transistors connected to the second transistor, and performs a switching operation with a differential between a positive signal and an inversion signal of a second signal to output a second output current to a second output terminal, wherein all of the transistors is npn bipolar transistors or n-channel MOS-FETs.

### CROSS-REFERENCE TO RELATED APPLICATIONS

This application is based upon and claims the benefit of priority from the prior Japanese Patent Applications No. 2004-057356, filed on Mar. 2, 2004, the entire contents of which are incorporated herein by reference.

### BACKGROUND OF THE INVENTION

1. Field of the Invention

The present invention relates to a charge pump circuit for use in a digital circuit or a synthesizer requiring a fast and precise clock signal, and a PLL circuit using the charge pump circuit, and more particularly to a charge pump circuit which outputs a precise clock signal with lower phase noise and less phase error without increasing the circuit scale and a PLL circuit using the charge pump circuit.

2. Description of the Related Art

The PLL (Phase Locked Loop) circuit is often employed as a clock signal generation circuit for an apparatus needing a fast and precise clock signal. For example, it is often employed for a sampling clock signal for an analog-digital (hereinafter abbreviated as AD) converter in a digital oscilloscope, or a clock signal for a digital circuit or synthesizer. And the charge pump circuit is employed in this PLL circuit.

FIG. 7 is a circuit block diagram showing one example of the conventional PLL circuit (e.g., refer to JP-A-2003-347935). In FIG. 7, a digital phase comparator PC has two D-type flip-flops DFF1, DFF2, and an AND gate G, and outputs a charge-up signal and a charge-down signal corresponding to a phase differential between a reference signal and a feedback signal.

A D-type flip-flop DFF1 inputs a reference signal as the clock signal, a high level signal as data, and a reset signal from the AND gate G. And the charge-up signal is outputted.

A D-type flip-flop DFF2 inputs a feedback signal as the clock signal, a high level signal as data, and a reset signal from the AND gate G. And the charge-down signal is outputted.

The AND gate G inputs the charge-up signal and the charge-down signal from the D-type flip-flops DFF1 and DFF2, and outputs a reset signal in which those signals are ANDed. That is, when both the charge-up signal and the charge-down signal are at high level, the reset signal is outputted, or when at least one of the charge-up signal and the charge-down signal is at low level, no reset signal is outputted.

The charge pump circuit 10 has a current switch circuit 12 for outputting an up-side current based on an up-side reference current source 11, if the charge-up signal is inputted, and a current switch circuit 14 for outputting a down-side current based on a down-side reference current source 13, if the charge-down signal is inputted. Also, the charge pump circuit 10 adds the up-side current and the down-side current, and outputs a charge pump output current of single end signal from a charge pump current output terminal 15.

A loop filter 20 comprises a condenser 21 for integrating (also called charging) the charge pump output current, and an operational amplifier 22 for outputting a control voltage obtained by converting the current integrated by the condenser 21 into voltage by comparison with a predetermined reference voltage Vref.

A voltage controlled oscillator (hereinafter abbreviated as VCO) 30 outputs an output signal (e.g., clock signal) having a frequency proportional to the control voltage from the loop filter 20. A frequency divider FD divides the clock signal from the VCO 30 into 1/N, and outputs a divided signal as the feedback signal to the digital phase comparator PC.

The operation of this circuit will be described below.

FIG. 8 is a diagram for exemplifying the operation of the circuit as shown in FIG. 7. In FIG. 8, from the upper stage, the waveforms of reference signal having a cycle period, feedback signal, charge-up signal from the phase comparator PC, charge-down signal from the phase comparator PC, charge pump output current of the charge pump circuit 10 (the direction from the charge pump circuit 10 to the loop filter 20 is supposed positive), and control voltage to the VCO 30 are shown. In an example of FIG. 8, the feedback signal is delayed in phase from the reference signal.

The D-type flip-flops DFF1, DFF2 and the AND gate G in the phase comparator PC output the charge-up signal and the charge-down signal corresponding to a phase differential between the reference signal and the feedback signal. That is, the flip-flop DFF1 outputs the charge-up signal at high level in active state in synchronism with a rising edge of the reference signal. On the other hand, the flip-flop DFF2 outputs the charge-down signal at high level in active state in synchronism with a rising edge of the feedback signal.

And if the charge-up signal and the charge-down signal are inputted from the flip-flops DFF1 and DFF2 into the AND gate G, the AND gate G outputs a reset signal to the flip-flops DFF1 and DFF2, so that the flip-flops DFF1 and DFF2 are reset and the charge-up signal and the charge-down signal are not outputted. That is, the charge-down signal has a narrow pulse width corresponding to only an amount of delay of the AND gate G. Since the reference signal has a cycle period, the charge-up signal having a pulse width corresponding to the phase differential and the charge-down signal are outputted periodically.

In contrast to the example of FIG. 8, if the feedback signal is advanced in phase from the reference signal, “pulse width of charge-up signal”<“pulse width of charge-down signal,” or if the feedback signal is in phase with the reference signal, “pulse width of charge-up signal”=“pulse width of charge-down signal”.

And the current switch circuits 12 and 14 of the charge pump circuit 10 are turned on or off by the charge-up signal and the charge-down signal from the phase comparator PC. Specifically, if the charge-up signal is inputted, the current switch circuit 12 is turned on, so that the up-side current is outputted to the loop filter 20 by the reference current source 11. On the other hand, if the charge-down signal is inputted, the current switch circuit 14 is turned on, so that the down-side current is outputted to the loop filter 20 by the reference current source 13.

The up-side current is discharged to the loop filter 20, and the down-side current is flowed in from the loop filter 20. And a sum of the up-side current and the down-side current is outputted as the charge pump output current from the output terminal 15 to the loop filter 20. In FIG. 8, due to “pulse width of charge-up signal”>“pulse width of charge-down signal”, the charge pump output current is discharged from the output terminal 15 of the charge pump circuit 10 to the loop filter 20. In this way, a differential signal from the phase comparator PC is converted into the single end signal for output.

And the charge pump output current is integrated by the condenser 21 of the loop filter 20. And the operational amplifier 22 outputs a control voltage, which is obtained from a voltage converted from the current integrated by the condenser 21 with a predetermined reference voltage Vref, to the VCO 30. In FIG. 8, the control voltage is increased for every period, whereby the oscillation frequency of the clock signal outputted from the VCO 30 is higher, so that the phase of the clock signal is advanced with respect to the reference signal. And the frequency divider FD divides the clock signal from the VCO 30 by N, and outputs a divided signal as the feedback signal to the flip-flop DFF2 of the phase comparator PC.

Referring to FIG. 9, the charge pump circuit 10 will be described below in detail. FIG. 9 is a circuit diagram of the charge pump circuit 10. In FIG. 9, the same parts are designated by the same numerals as in FIG. 7, and the explanation of those parts is omitted. In FIG. 9, the up-side current mirror circuit 16 comprises a pair of pnp bipolar transistors (hereinafter abbreviated as the pnp transistor) with each emitter connected to the constant voltage source Vcc, in which one pnp transistor has the collector and base connected to the reference current source 11, and is steadily turned on to cause the reference current to flow. Because of the current mirror circuit 16, the other pnp transistor is also turned on to cause the reference current to flow.

The current switch circuit 12 comprises a pair of pnp transistors, in which one pnp transistor is turned on or off by the charge-up signal. Also, the other pnp transistor is turned on or off by an inversion signal of the charge-up signal. And when one pnp transistor is on, the reference current from the other pnp transistor of the current mirror circuit 16 flows to a common potential, while when the other pnp transistor is on, the reference current from the other pnp transistor of the current mirror circuit 16 is outputted as the up-side current to the output terminal 15.

The down-side current mirror circuit 17 comprises a pair of npn bipolar transistors (hereinafter abbreviated as the npn transistor) with each emitter connected to the common potential point, in which one npn transistor has the collector and base connected to the reference current source 13, and is steadily turned on to cause the reference current to flow. Because of the current mirror circuit 17, the other npn transistor is also turned on to cause the reference current to flow.

The current switch circuit 14 comprises a pair of npn transistors, in which one npn transistor is turned on or off by the charge-down signal. Also, the other npn transistor is turned on or off by an inversion signal of the charge-down signal. And when one npn transistor is on, the reference current from the other npn transistor of the current mirror circuit 17 is outputted as the down-side current to the output terminal 15, while when the other npn transistor is on, the reference current flows from the constant voltage source Vcc to the other npn transistor of the current mirror circuit 17. A p-channel MOS-FET (hereinafter referred to as PMOS) may be employed instead of the pnp transistor for use in the up-side circuit, and an n-channel MOS-FET (hereinafter referred to as NMOS) may be employed instead of the npn transistor for use in the down-side circuit.

Referring to FIG. 10, another conventional example will be described below (e.g., refer to JP-A-2001-144610). In FIG. 10, the same parts are designated by the same numerals as in FIGS. 7 and 9, and the explanation and illustration of those parts are omitted. Though the output of the charge pump circuit 10 is the single end signal in the PLL circuit as shown in FIG. 7, the output of a charge pump circuit 40 is a differential signal in the PLL circuit as shown in FIG. 10. In FIG. 10, the charge pump circuit 40, a loop filter 50 and a VCO 60 are provided in place of the charge pump circuit 10, the loop filter 20 and the VCO 30.

The charge pump circuits 40 has two circuits corresponding to the charge pump circuit 10 as shown in FIG. 7 to make a differential. Specifically, the charge pump circuit 40 has the reference current sources 41, 42 connected to the constant voltage source Vcc, the reference current sources 43, 44 connected to the common potential point, a current switch circuit 45 turned on or off by the charge-up signal to output the reference current of the reference current source 41, a current switch circuit 46 turned on or off by the charge-up signal to output the reference current of the reference current source 43, a current switch circuit 47 turned on or off by the charge-down signal to output the reference current of the reference current source 42, and a current switch circuit 48 turned on or off by the charge-down signal to output the reference current of the reference current source 44. And the charge pump circuit 40 outputs a differential signal between the output current of a sum of the currents from the current switch circuit 45 and the current switch circuit 48 and the output current of a sum of the currents from the current switch circuit 46 and the current switch circuit 47 to the loop filter 50.

The loop filter 50 is provided with the condensers 51, 52 for integrating each output current. The VCO 60 has a voltage-current converter 61 for outputting a current corresponding to a differential voltage integrated by the condensers 51, 52 and a current controlled oscillator 62 whose frequency is controlled by the current outputted from the voltage-current converter 61.

The operation of this device will be described below. The different parts from the device as shown in FIG. 7 are mainly described. When the charge-up signal is in an active state, the current switch circuits 45, 46 are turned on. Thereby, the condenser 51 is charged, and the condenser 52 is discharged. Accordingly, the differential voltage of the voltage-current converter 61 is developed, so that the current outputted from the voltage-current converter 61 is increased, and the oscillation frequency of the clock signal outputted from the current controlled oscillator 62 is raised to advance the phase of the clock signal with respect to the reference signal.

On the other hand, when the charge-down signal is in the active state, the current switch circuits 47, 48 are turned on. Thereby, the condenser 52 is charged, and the condenser 51 is discharged. Accordingly, the differential voltage of the voltage-current converter 61 is reduced, so that the current outputted from the voltage-current converter 61 is decreased, and the oscillation frequency of the clock signal outputted from the current controlled oscillator 62 is diminished to delay the phase of the clock signal with respect to the reference signal.

JP-A-2003-347935 (paragraph number 0001-0012, FIGS. 3 to 8) and JP-A-2001-144610 (paragraph number 0042-0045, FIGS. 1 and 2) are referred to as related art.

Generally, the PLL circuit can suppress the high frequency noise of the VCO 30 and output the clock signal with low phase noise in the wider band. Referring to FIGS. 11A and 11B, the PLL circuit will be described below. FIG. 11A is a diagram showing the transfer characteristic of the PLL circuit. In FIG. 11B, supposing that the transfer function of a circuit including the charge pump circuit 10 and the phase comparator PC is Kd, the transfer function of the loop filter 20 is Z(s), the transfer function of the VCO 30 is Kv/s, and the dividing of the frequency divider FD is 1/N, the total transfer function (closed loop transfer function) G(s) of this PLL circuit is given by the following equation.
G(s)=(Kd·Kv·Z(s))/s
H=1/N

Accordingly, the transfer characteristic of the phase noise of the VCO 30 in the output of the PLL circuit is represented by the following equation.
“Transfer characteristic of phase noise of VCO 30”=|1/(G(s)·H)|

In FIG. 11B, ωc denotes the band of the PLL circuit. And the band ωc is the frequency predominantly decided by the operation rate of the charge pump circuit 10. That is, as the operation rate of the charge pump circuit 10 is faster, the band ωc is higher, making it possible to broaden the frequency domain where “transfer characteristic of phase noise of VCO 30”<1. Accordingly, the clock signal with low phase noise is obtained over the wide band.

However, in the circuits as shown in FIGS. 7 and 9, the pnp transistor (or PMOS) is employed in the up-side current switch circuit 12. Also, in the circuit as shown in FIG. 10, the current switch circuits of both polarities are needed for discharging and sucking the output current. For example, the current switch circuits 45, 47 for discharging the output current are composed of the pnp transistor (or PMOS). Therefore, even if the npn transistor (or NMOS) operating at high speed is employed in the down-side current switch circuit 14 or the current switch circuits 46, 48, the operation rate of the pnp transistor (or PMOS) is determining in the charge pump circuits 10, 40. Thus, the operation rate of the charge pump circuits 10, 40 is difficult to be faster.

Also, in the charge pump circuit 10 of the PLL circuit as shown in FIG. 7, it is inferior in the symmetry (operation rate or output current) in discharging and sucking the output current. That is, in constructing the PLL circuit, a differential in the operation rate causes a phase error between the reference signal and the feedback signal in the phase comparator PC. Also, the up-side current is on the basis of the reference current source 11, and the down-side current is on the basis of the reference current source 13. Therefore, when there is a differential in the current amount between the reference current sources 11, 13, the charge pump output current is asymmetric. For example, if the charge-up signal and the charge-down signal have the same pulse width, it follows that the up-side current is unequal to the down-side current. Such asymmetry of the charge pump output current results in a phase offset to the feedback signal to cause a phase error between the reference signal and the feedback signal, making the precision worse. Similarly, if the asymmetry of the charge pump output current was varied due to dispersion in the element characteristics on the current path between the up-side and the down-side or temperature changes, the phase error was caused, making the precision worse.

For example, in an interleave operation (high sampling operation in time division driven by a plurality of AD converters for the one-input measured signal (analog signal)) of a digital oscilloscope, a plurality of PLL circuits are employed. Referring to FIGS. 12A and 12B, the interleave operation will be described below. FIG. 12A is a diagram showing a circuit configuration for making the interleave operation with the digital oscilloscope, employing the PLL circuit as shown in FIG. 7. In FIG. 12, the same parts are designated by the same numerals as in FIG. 7, and the explanation of those parts is omitted. The phase comparator PC, the loop filter 20 and the frequency divider FD in the PLL circuit are not shown.

In an example of FIG. 12B, the AD converters ADCA to ADCD sample the analog signal with the clock signals CLKA, CLKB, CLKC and CLKD. When the interleave operation is performed, the clock signal CLKA synchronous with the reference signal and the clock signals CLKB, CLKC, CLKD in which the phase of clock signal is shifted (rising of clock signal is shifted) by giving a phase offset of different magnitude to the reference signal are generated by four PLL circuits.

The phase offset given to each PLL circuit is acquired by externally adding a phase offset current Ioffset1 to Ioffset3 to the charge pump output current of the charge pump circuit 10 in the PLL circuit. The phase offset is easily generated employing a digital-analog (hereinafter abbreviated as DA) converter (DAC1 to DAC3) of current output type.

And the clock signals CLKA, CLKB, CLKC and CLKD are given to the AD converters ADCA to ADCD to shift the start time of AD conversion. Therefore, if the asymmetry of the charge pump output current is varied, the phase error of clock signal is caused and the phase differential between each clock signal is varied. Therefore, it is difficult for the AD converter to make synchronization for the precise sampling.

On the other hand, in the circuit as shown in FIG. 10, though the symmetry (operation rate, output current) in discharging and sucking the output current is improved because the charge pump circuit 40 and the VCO 60 are differentiated. However, the circuit scale is increased.

### SUMMARY OF THE INVENTION

The object of the invention is to provide a charge pump circuit which outputs a precise clock signal with low phase noise and less phase error without increasing the circuit scale, and a PLL circuit using the charge pump circuit.

The invention provides a charge pump circuit having: a first transistor and a second transistor which constitute current mirror circuits with a reference transistor conducting a reference current; a first switch circuit which has a pair of transistors connected to the first transistor, and performs a switching operation with a differential between a positive signal and an inversion signal of a first signal to output a first output current to a first output terminal; and a second switch circuit which has a pair of transistors connected to the second transistor, and performs a switching operation with a differential between a positive signal and an inversion signal of a second signal to output a second output current to a second output terminal, wherein the reference transistor, the first transistor, the second transistor, the pair of transistors in the first switch circuit, and the pair of transistors in the second switch circuit are npn bipolar transistors or n-channel MOS-FETs.

The charge pump circuit further has: at least one phase offset transistor which constitutes a current mirror circuit with the reference transistor; and a phase offset current switch circuit which has a pair of transistors connected to the phase offset transistor, and performs a switching operation with a differential between a positive signal and an inversion signal of a phase offset setting current to output a first phase offset current according to the positive signal of the phase offset setting current to the first output terminal from one transistor and output a second phase offset current according to the inversion signal of the phase offset setting current to the second output terminal from another transistor, wherein the phase offset transistor and the pair of transistors in the phase offset current switch circuit are of the same type as the reference transistor.

In the charge pump circuit, the current amount of the phase offset current outputted from the phase offset current switch circuit is based on a mirror ratio of the current mirror circuit constituted by the reference transistor and the phase offset transistor.

The invention also provides a PLL circuit having: a voltage controlled oscillator which controls an oscillation frequency of an output signal by a control voltage; a phase comparator which compares a phase of a reference signal with a phase of a feedback signal based on the output signal outputted from the voltage controlled oscillator; the charge pump circuit according to claim 1, which is driven by a charge-up signal and a charge-down signal outputted from the phase comparator; and a loop filter, to which an up-side current and a down-side current outputted from the charge pump circuit is inputted, which converts a differential signal between the up-side current and the down-side current into a single end signal to apply a voltage of the single end signal to the voltage controlled oscillator, wherein the charge-up signal, the charge-down signal, the up-side current, and the down-side current are respectively the first signal, the second signal, the first output current, and the second output current.

The PLL circuit further has a frequency divider which divides the output signal outputted from the voltage controlled oscillator to output a divided signal as the feedback signal to the phase comparator.

According to the charge pump circuit, a pair of transistors provided in the first and second switch circuits, and the reference transistor, as well as the first and second transistors, making up the current mirror circuit are the npn transistors or NMOS, the fast switching operation is allowed, the symmetry between the first output current and the second output current only depends on the relative precision between transistors, but is not affected by absolute value dispersion or temperature changes. Thereby, it is possible to output the first output current and the second output current by correctly following the pulse width of the first signal and the second signal. That is, the operation rate of the charge pump circuit is faster, and the operation rate or output current is not asymmetric but excellently symmetric between the first and second switch circuits.

Since the first and second output currents are outputted by turning on or off a pair of transistors in the first and second switch circuits, the output of the charge pump circuit can be kept high during the off period. Accordingly, any one output current is not leaked to the circuit at the latter stage, whereby the symmetry is excellent.

Also, since the current mirror circuit is made up of the first and second transistors for the reference transistor, and the current switch circuit composed of a pair of transistors is connected to the first and second transistors, the circuit scale is reduced.

Accordingly, if the charge pump circuit is employed in the PLL circuit, the PLL circuit has a wider band, whereby the precise output signal with low phase noise and less phase error over the wide band can be outputted.

Furthermore, according to the charge pump circuit, since the output destination of the phase offset current in the phase offset current switch circuit is only switched, the symmetry of the first and second output currents is maintained even if the reference current flowing through the reference transistor is varied.

Also, since the phase offset transistor refers to the same reference current as the first and second transistors, the phase offset current from the phase offset current switch circuit is changed by tracking, even if the current amount of the first or second output current is changed by a variation in the reference current. Also, the relative precision of the first and second switch circuits is improved against temperature changes or element dispersion. Thereby, even if the reference current is varied, the ratio of current amount between the output currents is not changed. That is, when the PLL circuit is employed, the phase offset with respect to the reference signal is not changed.

Furthermore, according to the charge pump circuit, the phase offset, which is decided by the ratio of the phase offset current outputted from the phase offset current switch circuit making up the DA converter to the reference current, does not depend on the reference current. That is, since the current ratio is made by the relative ratio within the current mirror circuit, it is possible to achieve a very high relative precision in the IC construction. Thereby, when the PLL circuit is employed, a precise phase offset can be applied.

According to the PLL circuit, the charge pump circuit correctly follows the pulse width of the charge-up signal and the charge-down signal, and outputs the up-side current and the down-side current with excellent symmetry (operation rate, current amount) between the up-side current and the down-side current to the loop filter. Therefore, the precise clock signal with low phase noise and less phase error can be outputted without increasing the circuit scale.

Particularly, when the interleave operation is performed employing a plurality of AD converters, the phase offset control is allowed with high precision, high resolution and excellent linearity, and a phase differential between each clock signal to the AD converter becomes constant, whereby the sampling can be made synchronously and precisely.

### BRIEF DESCRIPTION OF THE DRAWINGS

FIG. 1 is a block diagram showing a first embodiment of the present invention;

FIG. 2 is a circuit diagram showing the configuration of a charge pump circuit in a PLL circuit as shown in FIG. 1;

FIG. 3 is a diagram for explaining one example of the operation of the circuit as shown in FIG. 1;

FIG. 4 is a block diagram showing a second embodiment of the invention;

FIGS. 5A and 5B are diagrams for explaining the operation of phase offset;

FIG. 6 is a circuit diagram showing the configuration in which the NMOS is employed in the circuit as shown in FIG. 2;

FIG. 7 is a block diagram of the conventional PLL circuit;

FIG. 8 is a diagram for explaining one example of the operation of the circuit as shown in FIG. 7;

FIG. 9 is a circuit diagram showing the configuration of the charge pump circuit in the conventional PLL circuit;

FIG. 10 is a circuit diagram showing another configuration of the conventional PLL circuit;

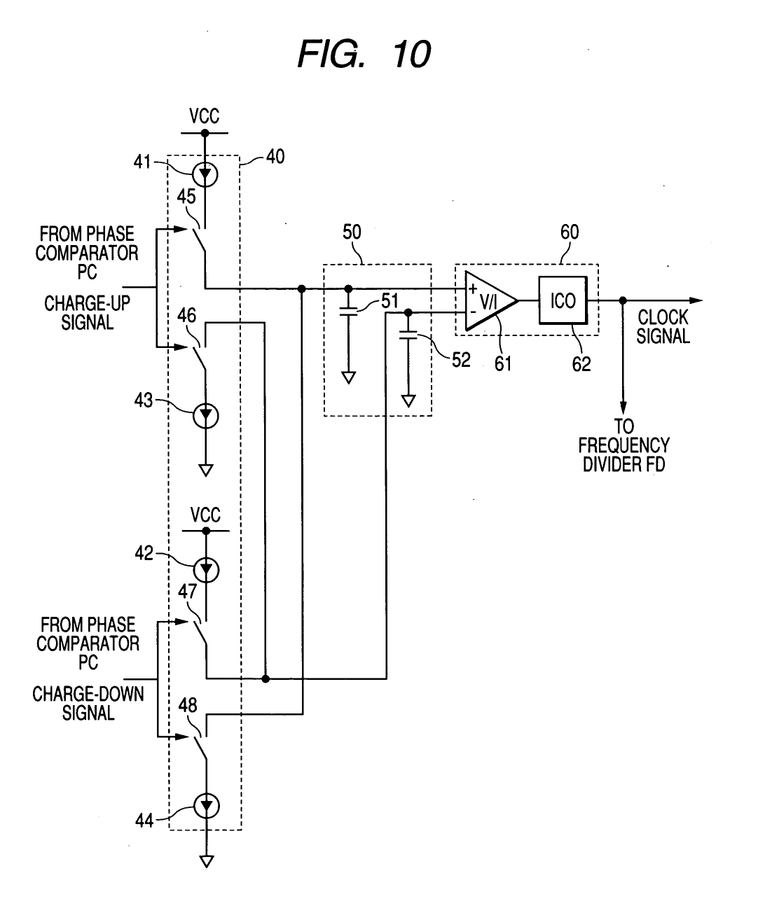

FIGS. 11A and 11B are diagrams showing the transfer characteristic of the PLL circuit; and

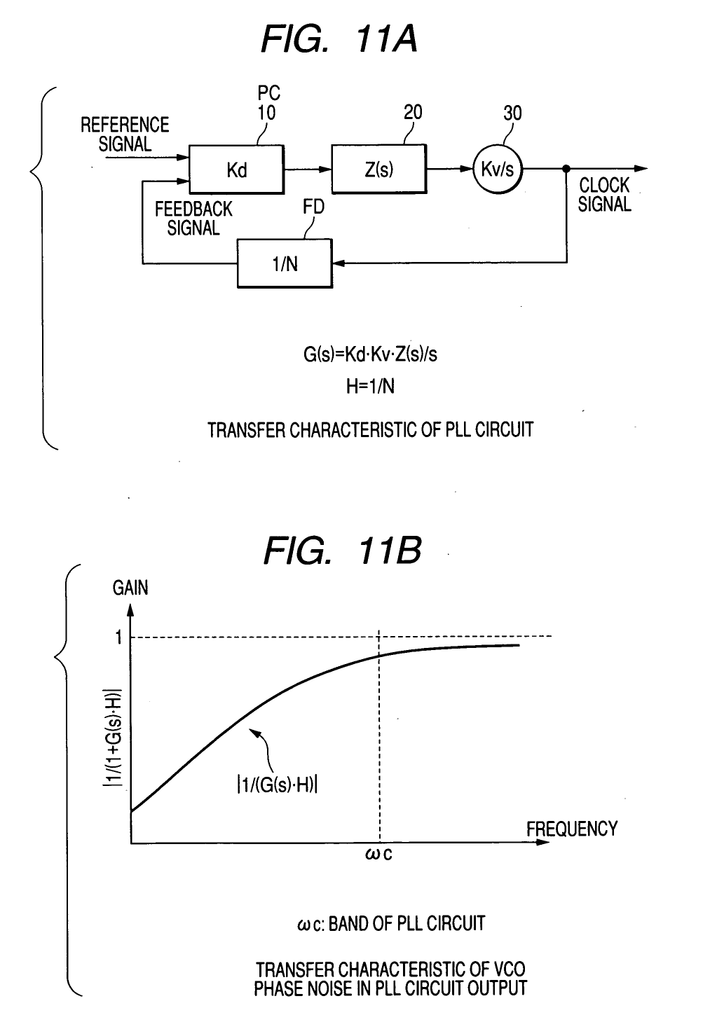

FIG. 12A is a diagram showing a circuit configuration for making the interleave operation with a digital oscilloscope, and FIG. 12B shows an example that AD converters ADCA to ADCD sample the analog signal with the clock signals CLKA, CLKB, CLKC and CLKD.

### DETAILED DESCRIPTION OF THE PREFERRED EMBODIMENTS

The preferred embodiments of the present invention will be described below with reference to the accompanying drawings.

<First Embodiment>

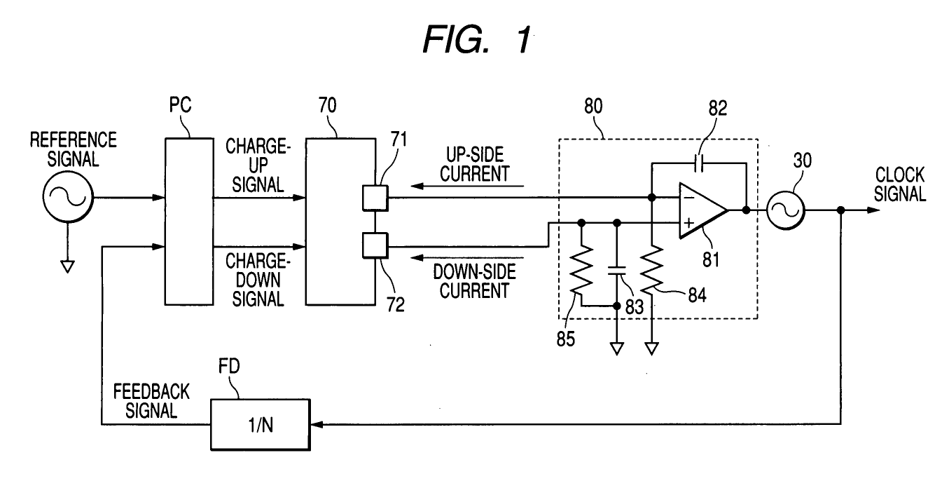

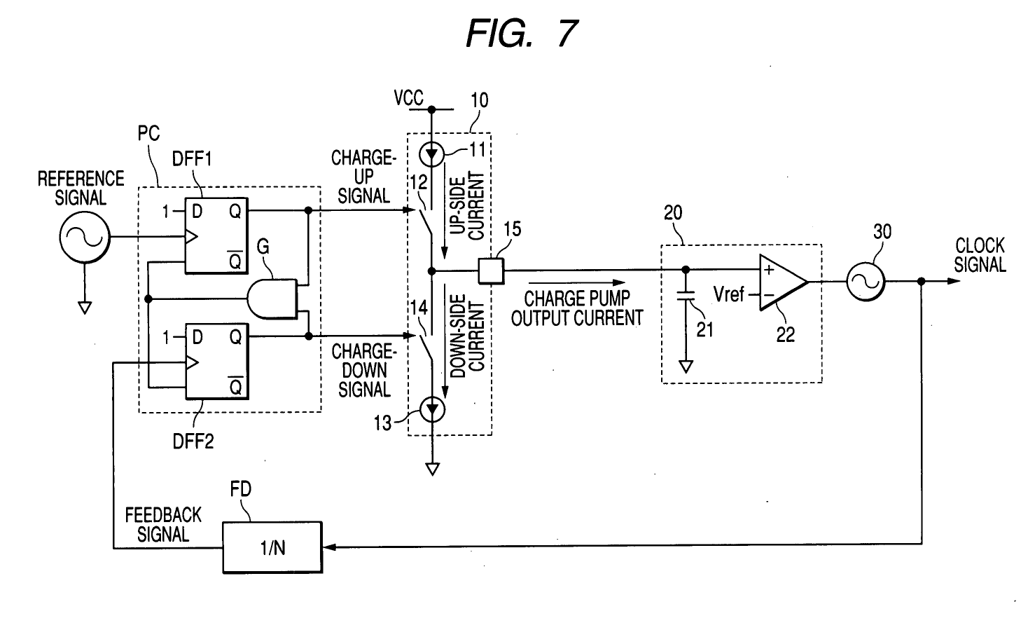

FIG. 1 is a block diagram showing a first embodiment of the invention. In FIG. 1, the same parts are designated by the same numerals as in FIG. 7, and the explanation and illustration of those parts are omitted. A charge pump circuit 70 and a loop filter 80 are provided in place of the charge pump circuit 10 and the loop filter 20.

The charge pump circuit 70 has an up-side output terminal 71 and a down-side output terminal 72. If a charge-up signal (first signal) is inputted from the phase comparator PC, the charge pump circuit 70 outputs an up-side current (first output current) from the output terminal 71. If a charge-down signal (second signal) is inputted from the phase comparator PC, the charge pump circuit 70 outputs a down-side current (second output current) from the output terminal 72. That is, the charge pump circuit 70 outputs the up-side current and the down-side current as the charge pump output current to the loop filter 80.

The loop filter 80 has an operational amplifier 81, the condensers 82, 83, and the resistors 84, 85, and converts a differential signal between the up-side current and the down-side current inputted from the charge pump circuit 70 into a single end signal to apply a voltage of the single end signal to the VCO 30.

The operational amplifier 81 has a reversal input terminal connected to the up-side output terminal 71, and a non-reversal input terminal connected to the down-side output terminal 72, with the output side being connected to the VCO 30. A condenser 82 is connected to the output side and the reversal input terminal of the operational amplifier 81 to form a negative feedback loop. A resistor 84 has one end connected to the output terminal 71, and the other end connected to a common potential point. Each of the condenser 83 and the resistor 85 has one end connected to the output terminal 72 and the other end connected to the common potential point.

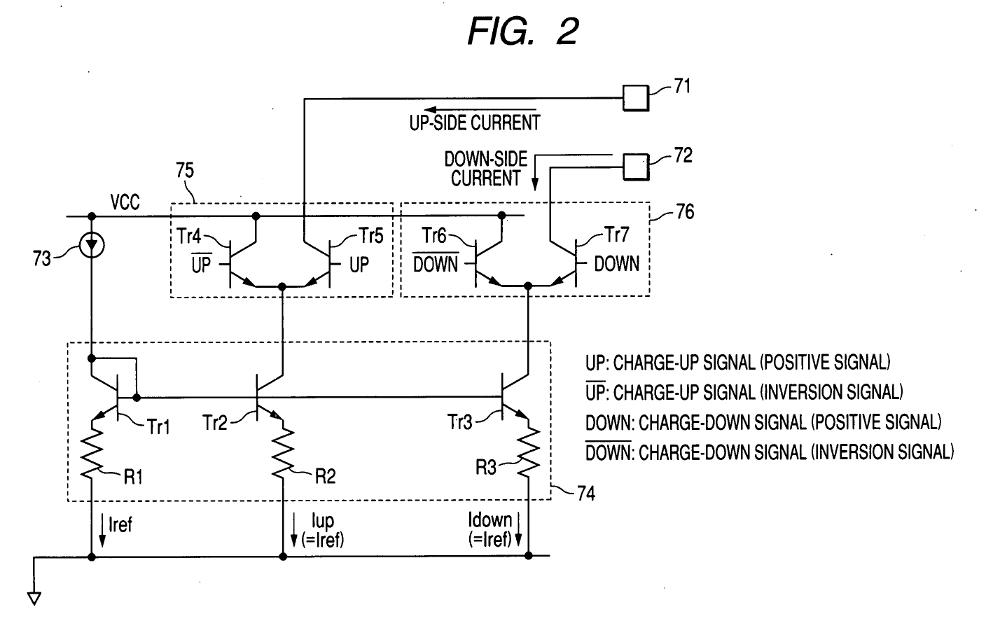

Referring to FIG. 2, the charge pump circuit 70 will be described below in detail. FIG. 2 is a circuit diagram of the charge pump circuit 70. In FIG. 2, the same parts are designated by the same numerals as in FIG. 1, and the explanation of those parts is omitted. The charge pump circuit 70 comprises the output terminals 71, 72, a reference current source 73, a current mirror circuit 74, an up-side current switch circuit 75, and a down-side current switch circuit 76, as shown in FIG. 2.

The reference current source 73 has one end connected to the constant voltage source Vcc. The current mirror circuit 74 has the transistors Tr1 to Tr3 and the resistors R1 to R3. The transistors Tr1 to Tr3 are the npn transistors.

A transistor Tr1 is a reference transistor, and has the connector and base connected to the other end of the reference current source 73 to conduct the reference current. A resistor R1 has one end connected to the emitter of the transistor Tr1 and the other end connected to the common potential point.

A transistor Tr2 is a first transistor, and has the base connected to the base of the transistor Tr1. A resistor R2 has one end connected to the emitter of the transistor Tr2 and the other end connected to the common potential point.

A transistor Tr3 is a second transistor, and has the base connected to the base of the transistor Tr1. A resistor R3 has one end connected to the emitter of the transistor Tr3 and the other end connected to the common potential point.

In this way, the current mirror circuit is made up of the transistors Tr2 and Tr3 for the reference transistor Tr1 conducting the reference current. Supposing that the currents flowing through the transistors Tr1, Tr2 and Tr3 are Iref, Iup and Idown, the mirror ratio of Iref=Iup=Idown is favorable in terms of the resistance ratios of the resistors R2, R3 to the resistor R1 and the emitter area ratios of the transistors Tr2, Tr3 to the transistor Tr1.

The up-side current switch circuit 75 is a first switch circuit, and has a pair of transistors Tr4, Tr5 to perform the switching operation with a differential between a positive signal and an inversion signal of the charge-up signal to output the up-side current to the output terminal 71. A transistor Tr4 has the collector connected to the constant voltage source Vcc, and the emitter connected to the collector of the transistor Tr2, with the inversion signal being inputted into the base. A transistor Tr5 has the collector connected to the output terminal 71, and the emitter connected to the collector of the transistor Tr2, with the positive signal being inputted into the base. The transistors Tr4, Tr5 are the npn transistors.

The down-side current switch circuit 76 is a second switch circuit, and has a pair of transistors Tr6, Tr7 to perform the switching operation with a differential between a positive signal and an inversion signal of the charge-down signal to output the down-side current to the output terminal 72. A transistor Tr6 has the collector connected to the constant voltage source Vcc, and the emitter connected to the collector of the transistor Tr3, with the inversion signal being inputted into the base. A transistor Tr7 has the collector connected to the output terminal 72, and the emitter connected to the collector of the transistor Tr3, with the positive signal being inputted into the base. The transistors Tr6, Tr7 are the npn transistors.

The operation of this device will be described below.

First of all, the operation in which a charge-up signal in an active state (at high level) is inputted into the charge pump circuit 70 will be described below. If a charge-up signal is inputted from the phase comparator PC to the charge pump circuit 70, a positive signal of the charge-up signal is inputted into the base of the transistor Tr5, and an inversion signal of the charge-up signal is inputted via a NOT circuit, not shown, into the base of the transistor Tr4. Thereby, the transistor Tr4 is turned off, and the transistor Tr5 is turned on, so that an up-side current flows from the output terminal 71 through the transistor Tr5, transistor Tr2 and resistor R2 to the common potential point. On the other hand, if the charge-up signal is not in the active state, the transistor Tr4 is turned on and the transistor Tr5 is turned off, so that no up-side current is outputted to the output terminal 71.

Subsequently, the operation in which a charge-down signal in an active state (at high level) is inputted into the charge pump circuit 70 will be described below. If a charge-down signal is inputted from the phase comparator PC to the charge pump circuit 70, a positive signal of the charge-down signal is inputted into the base of the transistor Tr7, and an inversion signal of the charge-down signal is inputted via the NOT circuit, not shown, into the base of the transistor Tr6. Thereby, the transistor Tr6 is turned off, and the transistor Tr7 is turned on, so that a down-side current flows from the output terminal 72 through the transistor Tr7, transistor Tr3 and resistor R3 to the common potential point. On the other hand, if the charge-down signal is not in the active state, the transistor Tr6 is turned on and the transistor Tr7 is turned off, so that no down-side current is outputted to the output terminal 72.

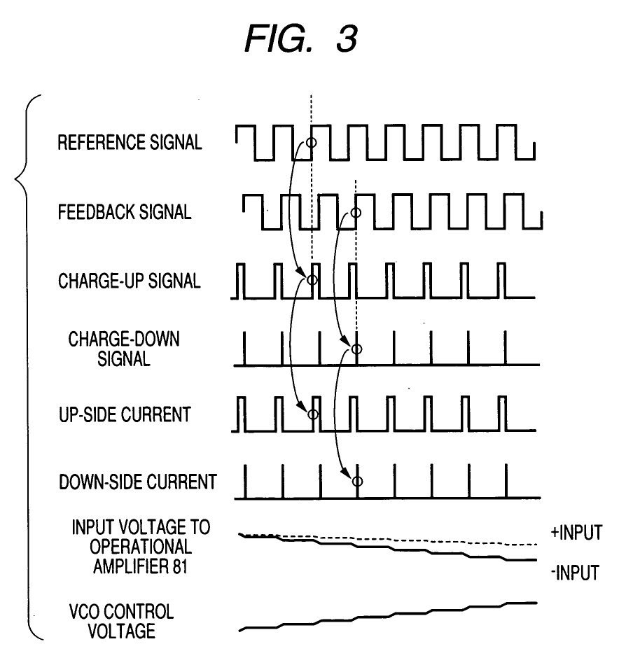

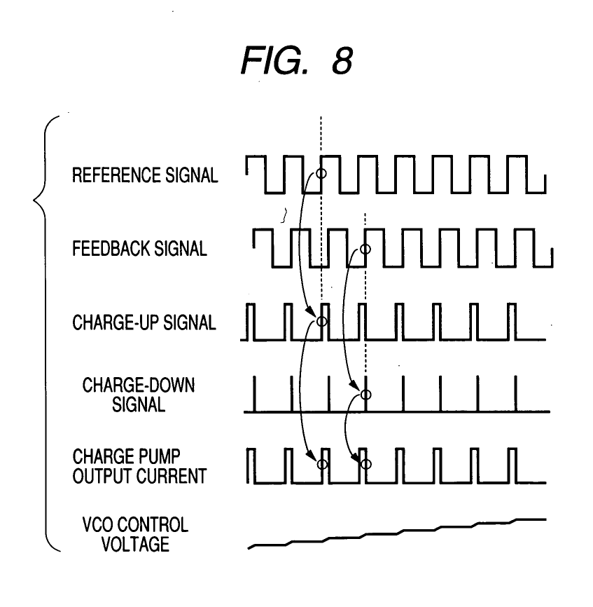

The operation of the PLL circuit will be described below. FIG. 3 is a diagram exemplifying the operation of the circuit as shown in FIGS. 1 and 2. In FIG. 3, the same parts are designated by the same numerals as in FIG. 8, and the explanation of those parts is omitted. In FIG. 3, from the upper stage, the waveforms of reference signal having a cycle period, feedback signal, charge-up signal from the phase comparator PC, charge-down signal from the phase comparator PC, up-side current of the charge pump circuit 70 (the direction from the loop filter 80 to the charge pump circuit 70 is supposed positive), down-side current of the charge pump circuit 70 (the direction from the loop filter 80 to the charge pump circuit 70 is supposed positive), input voltage into the input terminal of the operational amplifier 81, and control voltage to the VCO 30 are shown. In an example of FIG. 3, the feedback signal is delayed in phase from the reference signal, like the example of FIG. 8.

The phase comparator PC periodically outputs the charge-up signal and the charge-down signal, corresponding to a phase differential between the reference signal and the feedback signal. Since the feedback signal is delayed in phase from the reference signal, “pulse width of charge-up signal”>“pulse width of charge-down signal.”

Of course, in contrast to the example of FIG. 3, if the feedback signal is advanced in phase from the reference signal, “pulse width of charge-up signal”<“pulse width of charge-down signal,” or if the feedback signal is in phase with the reference signal, “pulse width of charge-up signal”=“pulse width of charge-down signal.”

And the current switch circuits 75 and 76 of the charge pump circuit 70 are turned on or off by the charge-up signal and the charge-down signal from the phase comparator PC. Specifically, if the charge-up signal in an active state is inputted, the up-side current is outputted from the output terminal 71 to the loop filter 80. On the other hand, if the charge-down signal in the active state is inputted, the down-side current is outputted from the output terminal 72 to the loop filter 80. In this case, the charge pump circuit 70, which is all composed of the npn transistors, outputs the up-side current and the down-side current, correctly following the pulse width of the charge-up signal and the charge-down signal.

In FIG. 3, owing to the relation of “pulse width of charge-up signal”>“pulse width of charge-down signal,” the voltage applied to the reversal input terminal is much lower than the voltage applied to the non-reversal input terminal of the operational amplifier 81. Accordingly, the control voltage from the operational amplifier 81 is increased for every period, and the oscillation frequency of the clock signal outputted from the VCO 30 is higher to advance the phase of the clock signal

The operation in which the VCO 30 outputs the clock signal, the operation in which the phase comparator PC outputs the charge-up signal and the charge-down signal from the feedback signal and the reference signal to the charge pump circuit 70, and the operation in which the frequency divider FD divides the clock signal from the VCO 30 to output the divided signal as the feedback signal to the phase comparator PC are the same as those of the device as shown in FIG. 7, and not described here.

In this way, since the transistors Tr4 to Tr7 of the current switch circuits 75, 76 are simply the npn transistors, the fast switching operation is allowed. Generally, since the npn transistor can operate faster by 10 or more times than the pnp transistor, the up-side current and the down-side current are outputted, correctly following the pulse width of the charge-up signal and the charge-down signal. That is, the operation rate of the charge pump circuit 70 is faster. Accordingly, when the charge pump circuit 70 operating fast is employed in the PLL circuit, the band ωc of the PLL circuit is also higher, whereby the clock signal with low phase noise is acquired over the wide band.

Also, since all the transistors Tr1 to Tr7 are the npn transistors, the up-side current and the down-side current has no asymmetry in the operation rate but excellent symmetry.

The current mirror circuit 74 is made up of the reference transistor Tr1 conducting the reference current and the transistors Tr2 and Tr3. And since the current switch circuits 75, 76 are connected to the transistors Tr2 and Tr3 to refer to the same reference current, there is no differential in the amount of current between the reference currents of the reference current sources 11 and 13. Thereby, the up-side current and the down-side current has excellent symmetry in the current amount.

Also, since the transistors Tr1 to Tr7 are simply the npn transistor elements, the symmetry between the up-side current and the down-side current depends only on the relative precision (normally about 5%) between the transistors Tr1 to Tr7, but is not affected by dispersion in the absolute value of amplification factor h_{FE} or temperature changes. Thereby, the phase error or variation caused by asymmetry is decreased, making it possible to generate the precise clock signal. Though the loop filter 80 converts the differential signal into the single end signal, the error between elements such as the resistors 84, 85 or condensers 82, 83 in the loop filter 80, commercially available, is as small as about 1%, and has almost no influence on the symmetry.

Since the bias current residing in the operational amplifier 81 for converting the differential signal becoming the charge pump output current into the single end signal is evenly added to the up-side current or the down-side current, it has no influence on the symmetry. Also, the asymmetry of the charge pump output current occurring due to the offset voltage of the operational amplifier 81, or the offset current, is sufficiently smaller than the charge pump output current. For example, assuming that the offset voltage is 1 [mV], and the input part resistance (resistors 83, 84 in FIG. 1) of the operational amplifier 81 is 1 [kΩ], the asymmetry in terms of the current is 1 [μA]. Also, assuming that the charge pump output current is 1 [mA], the asymmetry is as small as 0.1 [%]. Similarly, assuming that the input offset current is 1 [μA], the asymmetry is almost 0.1 [%], which is a fully small error.

Since the up-side current and the down-side current are outputted to the output terminal 71, 72 by turning on or off the transistors Tr5, Tr7, the output of the charge pump circuit 70 can be kept at high impedance during a period where both the up-side current and the down-side current are off, whereby any one current does not leak to the loop filter 80, with excellent symmetry.

Accordingly, the charge pump circuit 70 with excellent symmetry in terms of the current amount of the up-side current and the down-side current, as well as the operation rate, is employed in the PLL circuit, whereby the precise clock signal without phase variation and with less phase error is outputted.

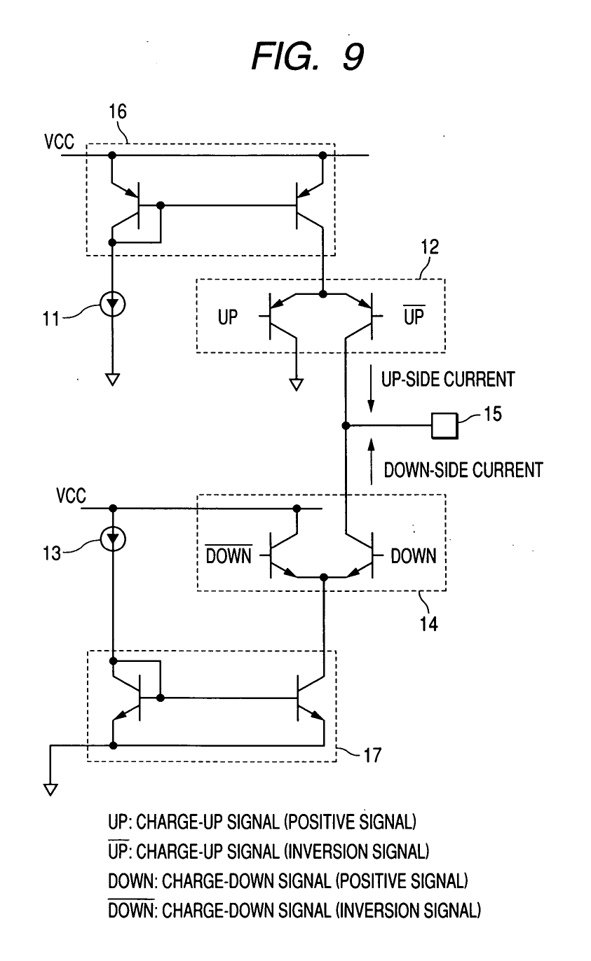

The current mirror circuit is made up of the transistors Tr2 and Tr3 for the reference transistor Tr1, and the current switch circuits 75, 76 composed of a pair of transistors are connected to the transistors Tr2 and Tr3, whereby the circuit scale is reduced. That is, though the charge pump circuit 10 as shown in FIG. 9 needs eight transistors, the charge pump circuit 70 as shown in FIG. 2 is composed of seven transistors.

Accordingly, since the charge pump circuit 70 as shown in FIG. 2 is employed in the PLL circuit, it is possible to output the precise clock signal with low phase noise and less phase error without increasing the circuit scale.

<Second Embodiment>

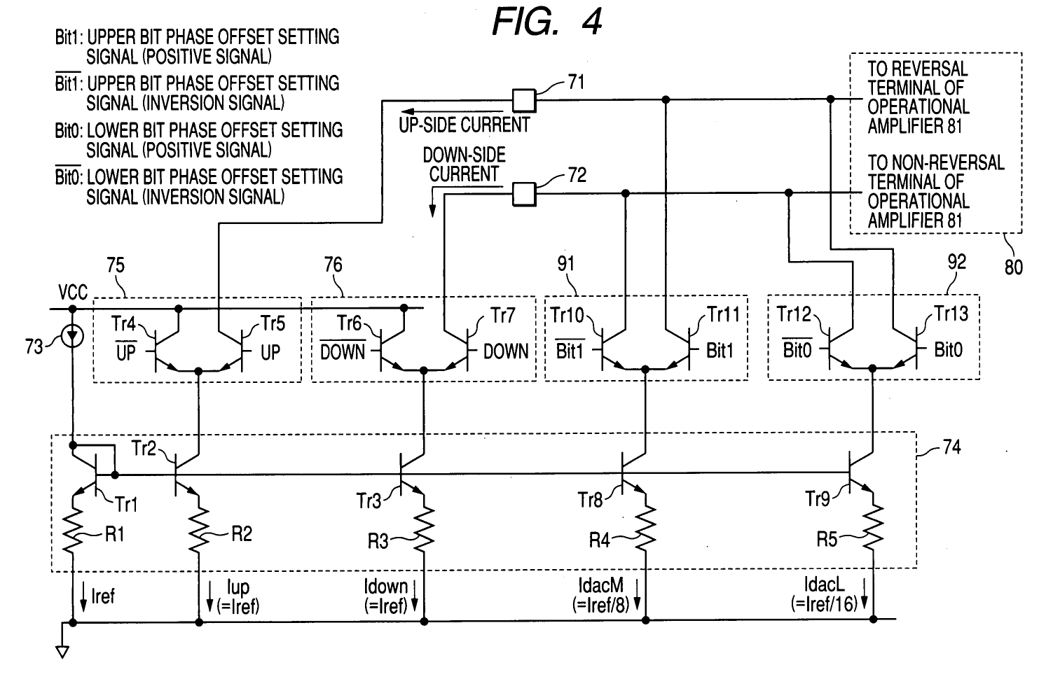

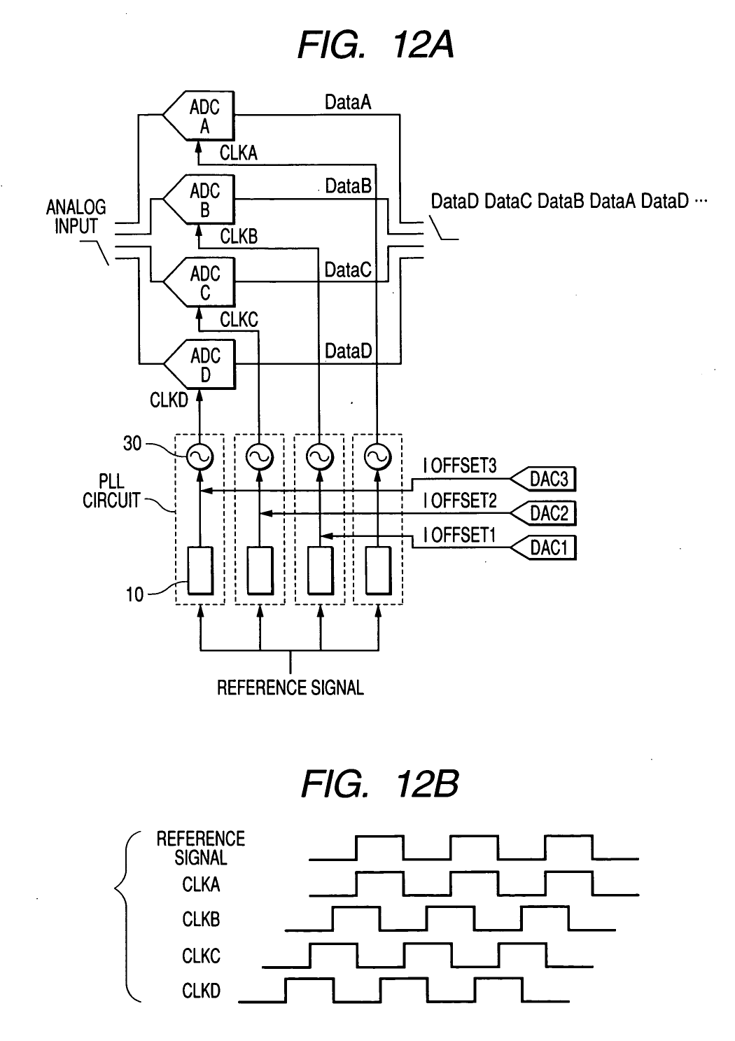

Though the interleave operation as shown in FIG. 12B may be performed by the device of FIG. 1, it is difficult to synchronize the clock signals CLKA to CLKD precisely, if there is a differential in the current amount between the DA circuits DAC1 to DAC3 outputting the phase offset current for phase offset. An example of outputting the phase offset currents loffset1 to loffset3 precisely will be described below. FIG. 4 is a block diagram showing a second embodiment of the present invention. In FIG. 4, the same parts are designated by the same numerals as in FIGS. 1 and 2, and the explanation and illustration of those parts are omitted. The resolution of the DA converter is 2 bits in this example.

In FIG. 4, a phase offset current switch circuit (MSB of DA converter) 91 and a phase offset current switch circuit (LSB of DA converter) 92 outputting the phase offset current to the output terminals 71, 72 upon a phase offset signal as the digital signal (2 bits in FIG. 4) are newly provided. These phase offset current switch circuits 91, 92 function as the DA converter. Also, the transistors Tr8, Tr9 and the resistors R4, R5 are newly provided in the current mirror circuit 74.

A transistor Tr8 of the current mirror circuit 74 is a phase offset transistor, with the base connected to the base of the transistor Tr1. A resistor R4 has one end connected to the emitter of the transistor Tr8, the other end being connected to the common potential point.

A transistor Tr9 of the current mirror circuit 74 is a phase offset transistor, with the base connected to the base of the transistor Tr1. A resistor R5 has one end connected to the emitter of the transistor Tr9, the other end being connected to the common potential point. The transistors Tr8, Tr9 of the current mirror circuit 74 are the npn transistors.

In this way, the current mirror circuit is made up of the transistors Tr2, Tr3, Tr8 and Tr9 for the reference transistor Tr1 conducting the reference current. Supposing that the currents flowing through the transistors Tr8 and Tr9 are IdacM and IdacL, it is favorable that the mirror ratios are IdacM=Iref/8 and IdacL=Iref/16, employing the resistance ratio of resistors R4 and R5 and the emitter area ratio of transistors Tr8 and Tr9, like the circuit as shown in FIG. 2.

The phase offset current switch circuit 91 has a pair of transistors Tr10, Tr11 to perform the switching operation with a differential between a positive signal and an inversion signal of the phase offset setting signal of MSB to output the phase offset current to the output terminals 71, 72. A transistor Tr10 has the collector connected to the output terminal 72, and the emitter connected to the collector of the transistor Tr8, with the inversion signal being inputted into the base. A transistor Tr11 has the collector connected to the output terminal 71, and the emitter connected to the collector of the transistor Tr8, with the positive signal being inputted into the base. The transistors Tr10, Tr11 are the npn transistors.

The phase offset current switch circuit 92 has a pair of transistors Tr12, Tr13 to perform the switching operation with a differential between a positive signal and an inversion signal of the phase offset setting signal of LSB to output the phase offset current to the output terminals 71, 72. A transistor Tr12 has the collector connected to the output terminal 72, and the emitter connected to the collector of the transistor Tr9, with the inversion signal being inputted into the base. A transistor Tr13 has the collector connected to the output terminal 71, and the emitter connected to the collector of the transistor Tr9, with the positive signal being inputted into the base. The transistors Tr12, Tr13 are the npn transistors.

The operation of this device will be described below.

A phase offset setting signal is inputted from a circuit, not shown, for controlling the amount of phase offset into the phase offset current switch circuits 91, 92 becoming the DA converter. For example, when the PLL circuit outputs a clock signal CLKB, the phase offset setting signal of “01” is inputted. Similarly, the phase offset setting signals of “10”, “11” are inputted for the clock signals CLKC, CLKD.

First of all, an instance in which the phase offset setting signal of “1” in active state (at high level) is inputted into each of the phase offset current switch circuits 91, 92 will be described. A positive signal of the phase offset setting signal is inputted into the base of the transistors Tr11, Tr13, and an inversion signal of the phase offset setting signal is inputted via a NOT circuit, not shown, into the base of the transistors Tr10, Tr12. Thereby, the transistors Tr10, Tr12 are turned off, and the transistors Tr11, Tr13 are turned on, so that a phase offset current IdacM flows from a signal line connecting to the output terminal 71 to transistor Tr11 to transistor Tr8 to resistor R4 to the common potential point, and a phase offset current IdacL flows from the signal line connecting to the output terminal 71 to transistor Tr13 to transistor Tr9 to resistor R5 to the common potential point. Owing to the phase offset currents IdacM, IdacL, the input voltage at the non-reversal input terminal of the operational amplifier 81 is decreased.

On the other hand, if the phase offset setting signal is not in the active state, the transistors Tr10, Tr12 are turned on, and the transistors Tr11, Tr13 are turned off, so that a phase offset current IdacM flows from a signal line connecting to the output terminal 72 to transistor Tr10 to transistor Tr8 to resistor R4 to the common potential point, and a phase offset current IdacL flows from the signal line connecting to the output terminal 72 to transistor Tr12 to transistor Tr9 to resistor R5 to the common potential point. Owing to the phase offset currents IdacM, IdacL, the input voltage at the non-reversal input terminal of the operational amplifier 81 is decreased.

For example, when the phase offset setting signal is “01” (i.e., when the clock signal CLKB is outputted), the phase offset current IdacM is outputted to the down-side current, and the phase offset current IdacL is outputted to the up-side current. And the loop filter 80 outputs a control voltage in which the differential signal is converted into the single end signal to the VCO 30. Moreover, the VCO 30 outputs the clock signal CLKB offset in phase from the reference signal.

The operation other than the above is the same as for the circuit shown in FIG. 1, and not described here.

In this way, since each of the phase offset current switch circuits 91, 92 only switches the phase offset current IdacM, IdacL to different output destination, the symmetry of the up-side current and the down-side current is maintained, even if the current Iref flowing through the reference transistor Tr1 is varied. Thereby, a positive phase offset and a negative phase offset of the reference signal and the feedback signal are symmetrical, improving the linearity of the phase offset with respect to the output from the DA converter.

Since the transistors Tr8, Tr9 refer to the same reference current Iref as the charge pump circuit 70, even if the current amount of the up-side current or down-side current from the charge pump circuit 70 is changed due to a variation in the reference current Iref, the phase offset current from the phase offset current switch circuits 91, 92 is also changed by tracking. Also, the relative precision of the charge pump circuit 70 against temperature changes or element dispersion is improved. From these, the phase offset is not changed even if the reference current Iref is varied.

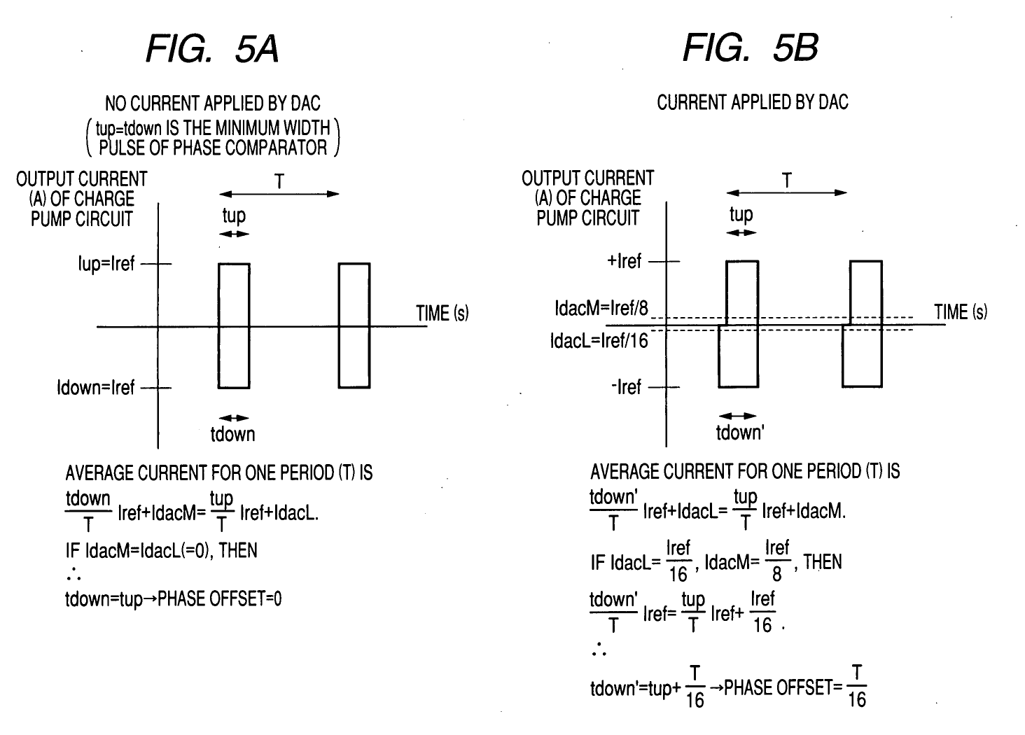

The phase offset, which is decided by the ratio of the phase offset current IdacM, IdacL outputted by the phase offset current switch circuits 91, 92 making up the DA converter to the reference current Iref, does not depend on the reference current Iref. For explanation, reference is made to FIGS. 5A and 5B. FIGS. 5A and 5B are diagrams for explaining the phase offset operation. FIG. 5A shows an instance in which the phase offset current is not applied by the DA converter, and FIG. 5B shows an instance in which the phase offset current is applied by the DA converter. In FIGS. 5A and 5B, the same parts are designated by the same numerals as in FIGS. 1 to 4, and the explanation of those parts is omitted. In FIGS. 5A and 5B, the transverse axis is the time, and the longitudinal axis is the up-side current on the upper side, and the down-side current on the lower side. Also, T denotes one period of reference signal, tup, tdown denote the minimum width pulse of the charge-up signal and the charge-down signal outputted from the phase comparator PC, and tdown′ denotes the pulse of the charge-down signal.

First of all, when the phase offset current is not applied, (phase offset)=0, because tdown=tup. On the other hand, when the phase offset current is applied (IdacM is outputted to the up-side current, and IdacL is outputted to the down-side current in FIGS. 5A and 5B), the average current for one period (T) is given by the following equation.
(tdown′/T)·Iref+IdacL=(tup/T)·Iref+IdacM

Herein, because IdacL=Iref/16 and IdacM=Iref/8, the following equation results.
(tdown′/T)·Iref=(tup/T)·Iref+Iref/16

That is, tdown′=tup+T/16, so that “phase offset”=“T/16.” That is, since the current ratio is made by the relative ratio in the current mirror circuit 74, a very high relative precision (e.g., about ±0.1%) is achieved in the IC construction. Thereby, the precise phase offset is applied.

Accordingly, the phase offset control is allowed with high precision, high resolution and excellent linearity, and if the circuit of FIG. 4 is employed for the interleave operation, the phase differential between each clock signal is constant, so that the AD converters ADCA to ADCD can make synchronization to make the sampling precisely.

The present invention is not limited to the above embodiments, but may be also implemented in the following way.

In the circuit as shown in FIG. 4, the phase offset current switch circuits 91, 92 having a resolution of 2 bits are shown, but the resolution may be any bits. Of course, in the resolution of n bits, the n phase offset transistors and n phase offset current switches making up the DA converter are needed.

In the circuit as shown in FIG. 4, the current ratios (i.e., mirror ratios) of the currents flowing through the phase offset current switch circuits 91, 92 of DAC are Iref/8, Iref/16, but may be any other value.

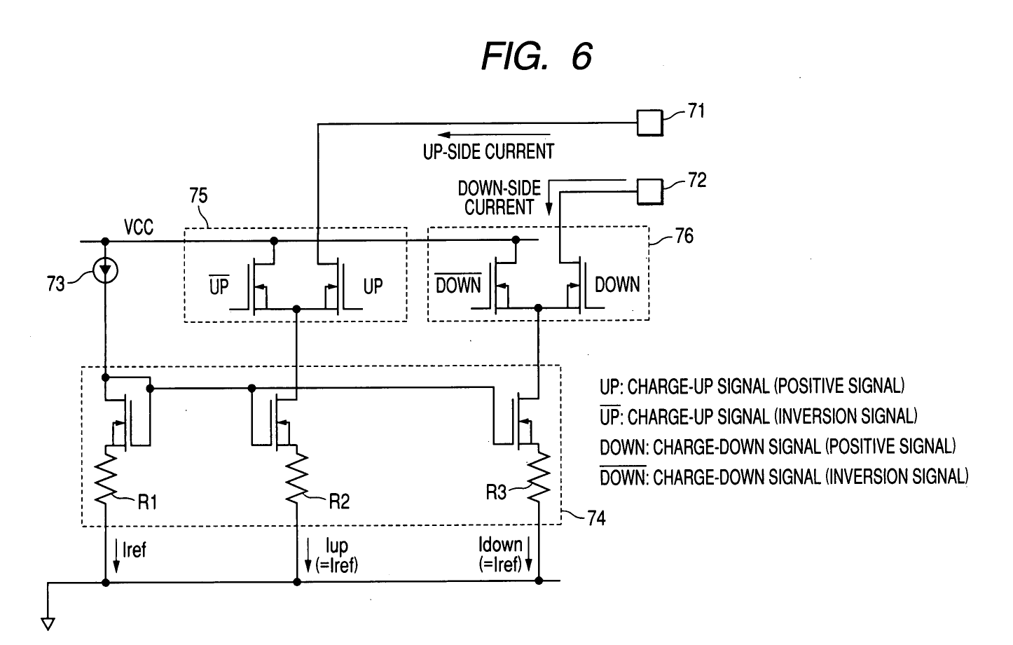

In the circuit as shown in FIGS. 2 and 4, the transistors Tr1 to Tr13 are the npn transistors, but the NMOS may be employed instead of the npn transistor. For example, the circuit of FIG. 2 may be configured as shown in FIG. 6. In FIG. 6, the same parts are designated by the same numerals as in FIG. 2. The transistors Tr10 to Tr13 and transistors Tr8, Tr9 of the phase offset current switch circuits 91, 92 may not be the npn transistors but the NMOS, and all the transistors Tr1 to Tr13 may be of the same type.

In this way, the PLL circuit using the NMOS as shown in FIGS. 1 and 4 may be incorporated as the clock signal generation circuit within the IC composed by the CMOS such as the CPU for use in the personal computer, for example. Generally, the MOS-FET is less expensive and capable of higher integration than the bipolar transistor, and thereby can achieve the reduction in the cost and size.

1. A charge pump circuit comprising:
a first transistor and a second transistor which constitute current mirror circuits with a reference transistor conducting a reference current;
a first switch circuit which has a pair of transistors connected to the first transistor, and performs a switching operation with a differential between a positive signal and an inversion signal of a first signal to output a first output current to a first output terminal; and
a second switch circuit which has a pair of transistors connected to the second transistor, and performs a switching operation with a differential between a positive signal and an inversion signal of a second signal to output a second output current to a second output terminal,
wherein the reference transistor, the first transistor, the second transistor, the pair of transistors in the first switch circuit, and the pair of transistors in the second switch circuit are npn bipolar transistors or n-channel MOS-FETs.

2. The charge pump circuit according to claim 1, further comprising:
at least one phase offset transistor which constitutes a current mirror circuit with the reference transistor; and
a phase offset current switch circuit which has a pair of transistors connected to the phase offset transistor, and performs a switching operation with a differential between a positive signal and an inversion signal of a phase offset setting current to output a first phase offset current according to the positive signal of the phase offset setting current to the first output terminal from one transistor and output a second phase offset current according to the inversion signal of the phase offset setting current to the second output terminal from another transistor,
wherein the phase offset transistor and the pair of transistors in the phase offset current switch circuit are of the same type as the reference transistor.

3. The charge pump circuit according to claim 2,
wherein the current amount of the phase offset current outputted from the phase offset current switch circuit is based on a mirror ratio of the current mirror circuit constituted by the reference transistor and the phase offset transistor.

4. A PLL circuit comprising:
a voltage controlled oscillator which controls an oscillation frequency of an output signal by a control voltage;
a phase comparator which compares a phase of a reference signal with a phase of a feedback signal based on the output signal outputted from the voltage controlled oscillator;
the charge pump circuit according to claim 1, which is driven by a charge-up signal and a charge-down signal outputted from the phase comparator; and
a loop filter, to which an up-side current and a down-side current outputted from the charge pump circuit is inputted, which converts a differential signal between the up-side current and the down-side current into a single end signal to apply a voltage of the single end signal to the voltage controlled oscillator,
wherein the charge-up signal, the charge-down signal, the up-side current, and the down-side current are respectively the first signal, the second signal, the first output current, and the second output current.

5. The PLL circuit according to claim 4, further comprising:
a frequency divider which divides the output signal outputted from the voltage controlled oscillator to output a divided signal as the feedback signal to the phase comparator.
